(19) United States
(12) Patent Application Publication
(10) Pub. No.: US 2010/0064278 A1
(43) Pub. Date: Mar. 11, 2010

(54) PROGRAMMING SYSTEM AND PROGRAM EXPANDING METHOD

(75) Inventors: CHUN-LIANG CHEN, Chungho City (TW); CHUNG-CHIEH YEH, Chungho-City (TW); YING-HSIEN KU, Chungho City (TW); YI-LI CHEN, Chungho City (TW)

Correspondence Address: BIRCH STEWART KOLASCH & BIRCH, PO BOX 747, FALLS CHURCH, VA, 22040-0747, US

(73) Assignee: ADLINK TECHNOLOGY INC., Chungho City (TW)

(21) Appl. No.: 12/408,312

(22) Filed: Mar. 20, 2009

(30) Foreign Application Priority Data
Sep. 5, 2008 (TW) 097134169

(51) Int. Cl. G06F 9/44

(52) U.S. Cl. 717/120

(57) ABSTRACT

The invention provides a programming system comprising a software component, a client side, and N expanding module. The software component comprises a receiving/processing interface and N first link interface; the client side could be used for transferring client information to the software component through the receiving/processing interface; and each expanding module is corresponding to one of the first link interface and comprises an expanding content. Accordingly, a connecting relation could be built between the software component and one expanding module, corresponding to the client information, of the N expanding module through the first link module, so that the software component can communicate with the expanding module to obtain the expanding content.

### BACKGROUND OF THE INVENTION

1. Field of the Invention

The invention relates to a programming system and a program expanding method, and more particularly, the invention relates to a programming system and a program expanding method capable of expanding the function of software component without modifying the source codes.

2. Description of the Prior Art

The computer hardware functions have grown more powerful recently because of the rapid development of semiconductors and computer technology. Concurrently, the computer software functions need to be progressive to match the computer hardware. The electrical devices nowadays emphasize the multi-functions, therefore, expanding methods for the functions of the software becomes an important issue.

In the prior art, the general method for expanding software functions is to modify the source codes of the program, and then encode and link the modified codes to achieve the expanding. However, because the method for expanding functions in the prior art requires the complex composing by the program designer, the cost would be higher. Furthermore, due to the modification of the source code in the method, the situation that the new functions work, but original functions do not work might occur.

In the prior art, the method for expanding the software functions can offer an expanding codes capable of providing the expanding functions, and then the source codes could be modified to point to the position of the expanding codes, to achieve the expanding function. However, this method still modifies the part of the source codes, so that the shortcoming in the last phase still exists in this method. This method may offer some paths that viruses could intrude into as well.

The description above mentions that the methods in the prior art all need to modify the source codes and they unavoidably cause the shortcomings mentioned above.

### SUMMARY OF THE INVENTION

Therefore, a scope of the invention is to provide a programming system for solving the above problems.

According to an embodiment, the programming system of the invention comprises a software component, a client side, and an expanding module. The software component comprises a receiving/processing interface and a plurality of first link interfaces, wherein the client side can transfer client information to the software component through the receiving/processing interface. The expanding module corresponds to one of the first link interfaces and comprises an expanding content.

In this embodiment, the software component can generate a connecting relation with the expanding module through one of the first link interfaces, and the software component can communicate with the expanding module according to the client information to obtain the expanding content. Practically, the software component can execute the function corresponding to the expanding content to achieve the effect that expanding the functions of the software component.

Another scope of the invention is to provide a program expanding method capable of being used in a programming system for expanding the functions of the software component.

According to an embodiment, the program expanding method comprises the following steps: firstly, storing an expanding module comprising an expanding content; and then, a software component generating a connecting relation with the expanding module through one of a plurality of first link interfaces; and then, a client side transferring a client information to the software component through a receiving/processing interface; finally, the software component communicating with the expanding module according to the client information to obtain the expanding content. Practically, the software component can execute the function corresponding to the expanding content to achieve the effect that expanding the functions of the software component.

In this embodiment, the software component can notify the client side when the software component generates the connecting relation with the expanding module through the first link interface. The client side can generate a response relative to the connecting relation. Practically, the response is that the client side announces that the client side obtains the expanding content could be that the client side announces that it obtains the expanding content.

The advantage and spirit of the invention may be understood by the following recitations together with the appended drawings.

### BRIEF DESCRIPTION OF THE APPENDED DRAWINGS

FIG. 1 is a schematic diagram illustrating a programming system according to an embodiment of the invention.

FIG. 2 is a schematic diagram illustrating a programming system according to another embodiment of the invention.

FIG. 3 is a schematic diagram illustrating a programming system according to another embodiment of the invention.

FIG. 4 is a flow chart illustrating a program expanding method according to an embodiment of the invention.

FIG. 5 is a flow chart illustrating a program expanding method according to another embodiment of the invention.

### DETAILED DESCRIPTION OF THE INVENTION

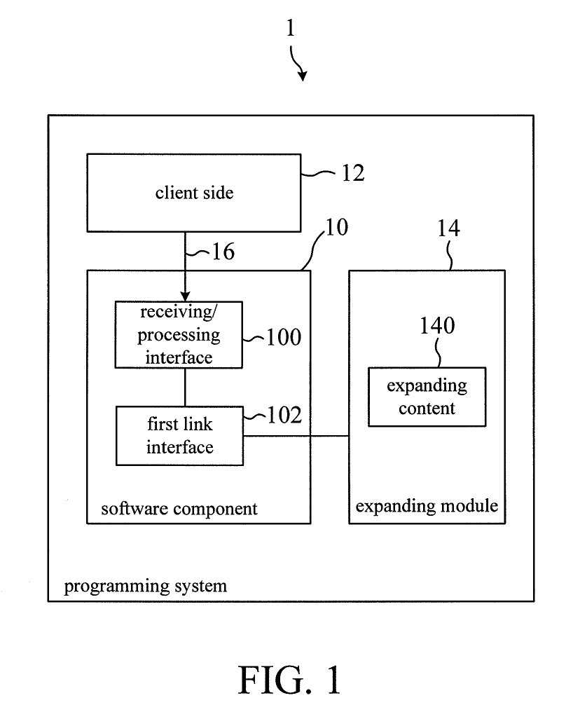

Please refer to FIG. 1. FIG. 1 is a schematic diagram illustrating a programming system 1 according to an embodiment of the invention. As shown in FIG. 1, a software component 10 of the programming system 1 can comprise a receiving/processing interface 100 and a first link interface 102. A client side 12 corresponds to the software component 10, and the client side 12 can transfer client information 16 to the software component 10 through the receiving/processing interface 100.

In this embodiment, an expanding module 14 corresponds to the first link interface 102 of the software component 10, and the expanding module 14 comprises an expanding content 140. The software component 10 can generate a connecting relation with the expanding module 14 through the first link interface 102. According to the client information 16 received by the receiving/processing interface 100 from the client side 12, the software component 10 can communicate with the expanding module 14 to obtain the expanding content 140.

In practice, the client information 16 is the input data inputted by a user through the client side 12, and the client information 16 can comprise, but not limited to, property, method, or event. After the receiving/processing interface 100 receives the client information 16, the receiving/processing interface 100 or the software component 10 can search the corresponding first link interface 102 according to the client information 16 and communicate with the expanding module 14 through the first link interface 102 to obtain the expanding content 140.

In practice, after the communication with the expanding module 14 through the first link interface 102 and obtaining the expanding content 140, the software component 10 can execute the function corresponding to the expanding content 140. The expanding module could be a dynamic link library (DLL), and the expanding content 140 can comprise an visual component or an expanding function. For example, if the expanding content 140 is an visual component, the software component 10 can show the setting image relative to the software component 10 or the image of the execution of the software component 10 on the display, such as showing a bottom (the software component 10) or a setting image for setting the size of the bottom on the display.

If the expanding content 140 is an expanding function in practice, the software component 10 can execute the expanding function. For example, if the expanding content 140 is the function for searching a hardware element, the software component 10 can search the corresponding hardware element according to the expanding content 140. Furthermore, if the expanding content 140 is the function for setting a hardware element, the software component 10 can set the corresponding hardware element according to the expanding content 140.

As described in the above phases, the software component 10 can generate a connecting relation with the expanding module 14 corresponding to the first link interface 102. Practically, the user can transfer the client information 16 to the software component 10 through the client side 12, and then the software component 10 can communicate with the expanding module 14 to obtain the expanding content 140 according to the client information 16 and the connecting relation. After obtaining the expanding contain 140, the software component 10 can execute the visual component or the expanding function of the expanding content 140. Accordingly, the images or the functions could be expanded without modifying the source codes of the software component 10.

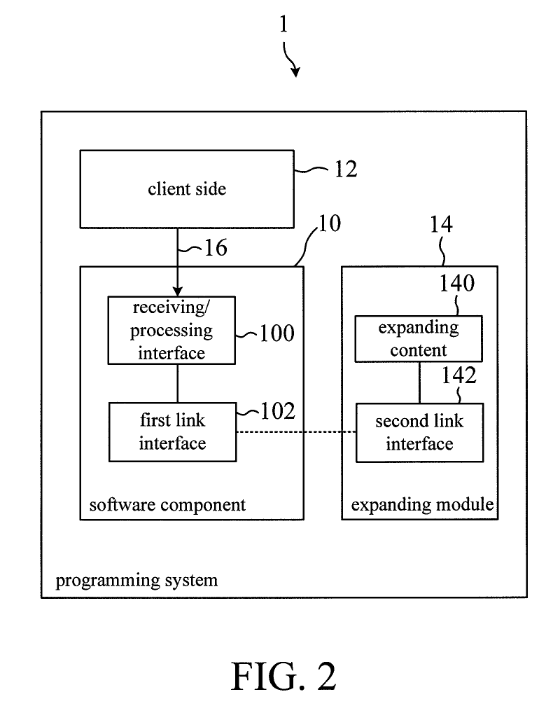

Please refer to FIG. 2. FIG. 2 is a schematic diagram illustrating the programming system 1 according to another embodiment of the invention. As shown in FIG. 2, the difference between this embodiment and the last embodiment is that the expanding module 14 in this embodiment further comprises a second link interface 142, wherein the second link interface 142 is corresponding to the first link interface 102. In this embodiment, the software component 10 can communicate with the expanding module 14 to obtain the expanding content 140 through the first link interface 102 and the second link interface 142.

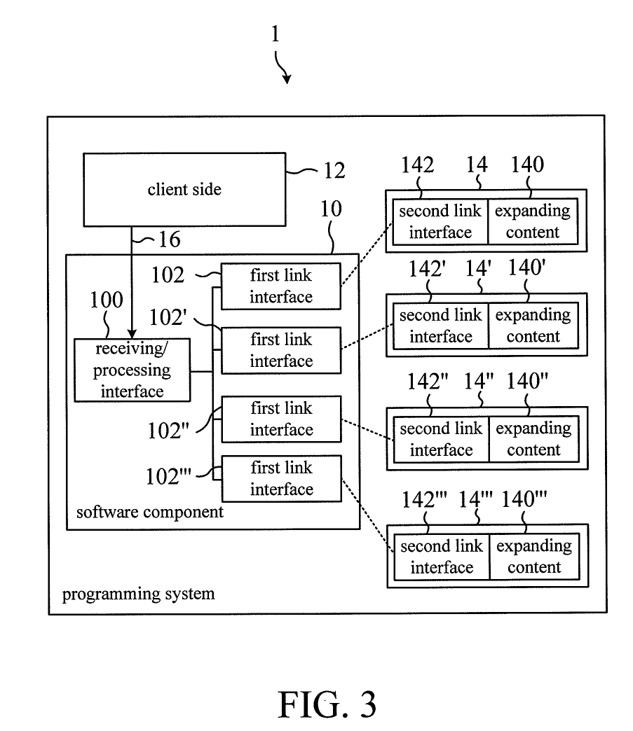

Furthermore, please refer to FIG. 3. FIG. 3 is a schematic diagram illustrating the programming system 1 according to another embodiment of the invention. As shown in FIG. 3, the difference between this embodiment and the last embodiment is that the programming system 1 in this embodiment comprises a plurality of expanding modules 14, 14′, 14″, and 14′″. It should be noted that the expanding modules 14, 14′, 14″, and 14′″ respectively comprise the expanding contents 140, 140′, 140″, and 140′″ with different functions in this embodiment. For example, the expanding content 140 provides an image expanding function, and the expanding content 140′″ provides a hardware setting function. In this embodiment, through the second link interface cooperating with the corresponding first link interface, each of the expanding modules generating the connecting relation with the software component, therefore, the software component can search the corresponding first link interface according to the client information to communicate with each of the expanding module. It should be noted that the other portions of the programming system 1 in this embodiment are the same with those in the above-mentioned embodiment, and it would not be described here.

For example, if the first link interface 102′ is corresponding to the searching function, the expanding module 14′ with the expanding content 140′ having a searching function further comprises the second link interface 142′ corresponding to the first link interface 102′, and the expanding module 14′ can generate a connecting relation with the software component 10 through the second link interface 142′ and the first link interface 102′. When the user would like to expand the software component 10 with the searching function, he can transfer the client information 16 to the receiving/processing interface 100 through the client side 12, and then the software component 10 can find the first link interface 102′ according to the client information 16, so that the software component 10 can further communicate with the expanding module 14′ to obtain the expanding content 140′ having a searching function through the first link interface 102′ and the second link interface 142′.

It should be noted that different communicating methods could be provided according to the types of the first link interface and the second link interface. For example, if the software component finds the first link interface relative to the searching function according to the client information and the first link interface connects to the corresponding second link interface and the expanding module with a searching function, the software component can communicate with the expanding module by the communicating method relative to the searching function. Similarly, if the first link interface and the second link interface are relative to the image setting function, the software component can communicate with the expanding module by the communicating method relative to the image setting function.

As described in the above phases, the software component just needs the first link interfaces corresponding to the expanding modules for communicating with various expanding modules and obtaining the expanding contents, therefore, the expanding of the software component could be achieved without modifying the source codes.

According to another embodiment, when the software component generates the connecting relation with expanding module through the first link interface and the second link interface, the software component can notify the client side, and then the client side can generate a response relative to the connecting relation accordingly. The response could be that the client side announces that the expanding content of the expanding module is obtained (by the software component).

For example, when the expanding module with a searching function generates the connecting relation with the software component through the corresponding first link interface and second link interface, the software component can notify the client side that the software component generates the connecting relation with the expanding module with the searching function, and then, the client side generates a response relative to the connecting relation accordingly, in other words, the client side announces that the expanding content with a searching function is obtained (by the software component). Therefore, the user could be notified of the functions provided to the software component by the responses in practice.

Furthermore, according to another embodiment, if the user would like to know what function the software component has, the user can transfer a query command to the software component through the client side and the receiving/processing interface to search the expanding function of the software component, and then the software component can search the connecting relation relative to the expanding function according to the query command and reply the client side according to the result of the searching.

For example, if the user would like to know whether the software component is provided with the hardware setting function, he can transfer a query command relative the hardware setting function to the software component through the client side. The software component searches the connecting relation generated between the software component and the hardware setting expanding module according to the query command received and replies the client side with the result of the searching. Therefore, the user can know whether the software component is provided with the hardware setting function according to the result of the searching.

The expanding modules could be placed in the specific folder, and generate the connecting relations with the first link interfaces and the software component through a specific path. It should be noted that each of the expanding modules could be placed in the same folder and generate the connecting relations with the software component through the same path, or the expanding modules could be respectively placed in the different folders and generate the connecting relations with the software component through the different paths, and it depends on the requests of the user or the designer.

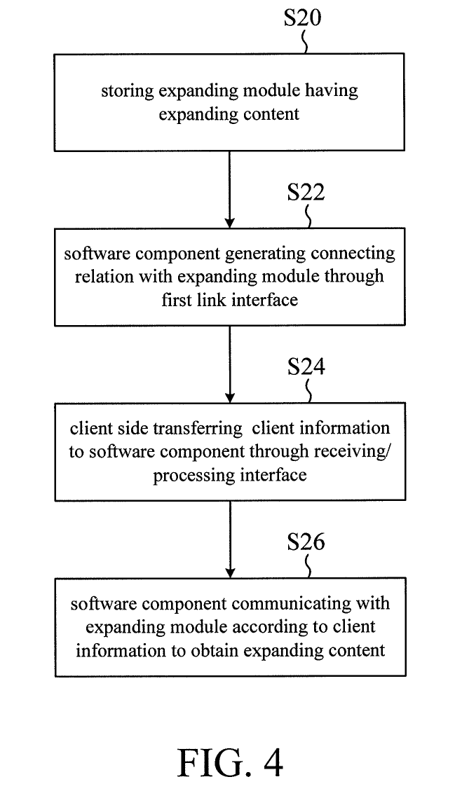

Please refer to FIG. 4. FIG. 4 is a flow chart illustrating a program expanding method according to an embodiment of the invention. As shown in FIG. 4, the program expanding method comprises the following steps: in step S20, storing the expanding module having the expanding content; in step S22, the software component generating the connecting relation with the expanding module through the first link interface; in step S24, the client side transferring the client information to the software component through the receiving/processing interface; and in step S26, the software component communicating with the expanding module according to the client information to obtain the expanding content.

The details of the program expanding method in the embodiment would be described in the followings. In step S20, the expanding module is stored in the specific folder. In practice, several expanding modules could be stored in single specific folder or respectively stored in several specific folders, and it depends on the requests of the user or the designer. Besides, the expanding module could be, but not limited to, a dynamic link library.

In step S22, the first link interface of the software can point to and generate the connecting relation with the expanding module stored in the specific folder through the specific path. The types of the first link interfaces are corresponding to the types of the expanding modules. For example, if the expanding module comprises the expanding content with searching function, the corresponding first link interface should be relative to the searching function for generating the connecting relation with the expanding module. In practice, several first link interfaces relative to different expanding functions could be configured in the software component, and each of the expanding modules can respectively comprise the second link interface relative to the expanding content. When an expanding module with an expanding function is stored in the specific folder, the first link interface relative to the expanding function can generate the connecting relation with the second link interface of the expanding module, that is, the software component generates the connecting relation through the first link interface and the second link interface.

In step S24, the client information transferred by the client side could be, but not limited to, property, method, or event in practice. The software component can point to the first link interface according to the client information. In other words, the user can make the software component to point to the first link interface relative to an expanding function by transferring the client information relative to the expanding function.

In step S26, the software component points to the first link interface relative to the expanding function according to the client information, and communicates to the expanding module through the first link interface to obtain the expanding content. Practically, the software component can generate the connecting relation through the first link interface and the corresponding second link interface. Therefore, the software component can communicate with the expanding module through the first link interface and the corresponding second interface to obtain the expanding content.

In practice, the software component can execute the expanding function or the visual component of the expanding content after receiving the expanding content. For example, if the expanding content comprises the searching function, the software component can execute the search function after receiving the expanding function.

As described in the above phases, the program expanding method can expand the functions of the software component by connecting the software component and the expanding modules respectively corresponding to the first link interfaces of the software component, but without modifying the source codes.

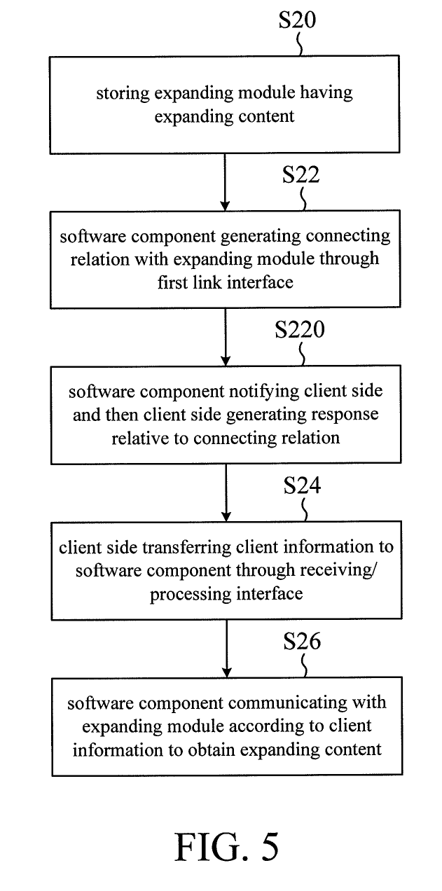

Please refer to FIG. 5. FIG. 5 is a flow chart illustrating the program expanding method according to another embodiment of the invention. As shown in FIG. 5, the difference between this embodiment and the last embodiment is the program expanding method in this embodiment further comprises the following steps: in step S220, the software component notifying the client side and then the client side generating a response relative to the connecting relation when the software component generates the connection relation with the expanding module through the first link interface.

In this embodiment, the response generated by the client side is that the client side announces that the expanding content is obtained in step S220. For example, if the expanding module comprises and expanding content with a searching function, the software component can notify the client side and then the client side announces that the software component has the searching function accordingly when the software component generates the connecting relation with the expanding module. Therefore, the user can know what functions the software component is provided with according to the response in practice.

Furthermore, according to another embodiment, the software component would not notify the client side actively when generating the connecting relation with the expanding module through the first link interface. If the user would like to know what expanding function the software component is provided with, the user can transfer a query command to the software component through the client side and the receiving/processing interface to search the expanding function of the software component, and then the software component searches the connecting relation relative to the expanding function according to the query command and replies the client side according to the result of the searching.

For example, if the user would like to know whether the software component is provided with the hardware setting function, the user can transfer the query command relative to the hardware setting function through the client side to the software component. The software component searches the connecting relation generated between the software component and the hardware setting expanding module according to the query command received and replies the client side with the result of the searching. Therefore, the user can know whether the software component is provided with the hardware setting function according to the result of the searching.

Compared with the prior art, the programming system and the program expanding method of the invention configure various first link interfaces in software component and a second link interface, relative to the expand function of the expanding module, in the expanding module. The software component can communicate with the expanding module through the second link interface and the corresponding first link interface to obtain the expanding content of the expanding module, and further execute the expanding function of the expanding content. Accordingly, the functions of the software component could be expanded without modifying the source codes to decrease the cost and avoid the original functions error.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A programming system, comprising:
a software component, comprising a receiving/processing interface and N first link interfaces, N being an integer larger than or equal to 1;
a client side, corresponding to the software component, for transferring a client information to the software through the receiving/processing interface;
an expanding module, corresponding one of the N first link interfaces, the expanding module comprising an expanding content;
wherein the software component generates a connecting relation with the expanding module through one of the N first link interfaces and communicates with the expanding module to obtain the expanding content according to the client information.

2. The programming system of claim 1, wherein the software component notifies the client side and then the client side generates a response relative to the connection relation when the software component generates the connecting relation with the expanding module through one of the first link interfaces.

3. The programming system of claim 2, wherein the response is that the client side announces that the expanding content is obtained.

4. The programming system of claim 1, wherein the client side is capable of transferring a query command to the software component through the receiving/processing interface, the software component is capable of searching the connecting relation according to the query command and replying the client side according to the result of the searching.

5. The programming system of claim 1, wherein the client information comprises at least one in the following group consisted of property, method, and event.

6. The programming system of claim 1, wherein the expanding module is a dynamic link library.

7. The programming system of claim 1, wherein the expanding module comprises a second link interface for cooperating with one of the N first link interfaces to generate the connecting relation.

8. The programming system of claim 1, wherein the expanding content comprises an visual component or an expanding function.

9. The programming system of claim 8, wherein the visual component comprises a setting image or an element image.

10. The programming system of claim 8, wherein the expanding function comprises a searching function and a hardware setting function.

11. A program expanding method, used in a programming system, the program expanding method comprises the following steps:
storing an expanding module comprising an expanding content;
a software component generating a connecting relation with the expanding module through one of N first link interfaces, wherein N is an integer large than of equal to 1;
a client side transferring a client information to the software component through a receiving/processing interface;
the software component communicating with the expanding module according to the client information to obtain the expanding content.

12. The program expanding method of claim 11, further comprising the following steps:
the software component notifying the client side and then the client side generating a response relative to the connecting relation when the software component generating the connection relation with the expanding module through one of the N first link interfaces.

13. The program expanding method of claim 12, wherein the response is that the client side announces that the expanding content is obtained.

14. The program expanding method of claim 11, further comprising the following steps:
the client side transferring a query command to the software component through the receiving/processing interface; and
the software component searching the connecting relation according to the query command and replying the client side according to the result of the searching.

15. The program expanding method of claim 11, wherein the client information comprises at least one in the following group consisted of property, method, and event.

16. The program expanding method of claim 11, wherein the expanding module is a dynamic link library.

17. The program expanding method of claim 11, wherein the expanding module comprises a second link interface for cooperating with one of the N first link interface to generate the connecting relation.

18. The program expanding method of claim 11, wherein the expanding content comprises an visual component or an expanding function.

19. The program expanding method of claim 11, wherein the visual component comprises a setting image or an element image.

20. The program expanding method of claim 11, wherein the expanding function comprises a searching function and a hardware setting function.
